(19) United States
(12) Patent Application Publication
(10) Pub. No.: US 2025/0371390 A1
(43) Pub. Date: Dec. 4, 2025

(54) MANAGING INFERENCE MODELS USING CONCEPT-BASED REPRESENTATIONS OF GRAPHICAL INFERENCES

(71) Applicant: Dell Products L.P., Round Rock, TX (US)

(72) Inventors: OFIR EZRIELEV, Beer Sheva (IL); TOMER KUSHNIR, Omer (IL); AMIHAI SAVIR, Newton, MA (US)

(21) Appl. No.: 18/678,719

(22) Filed: May 30, 2024

(51) Int. Cl. G06N 5/045; G06T 11/20

(52) U.S. Cl. CPC G06N 5/045; G06T 11/203

(57) ABSTRACT

Methods and systems for managing a generative inference model are disclosed. Using the generative inference model and ingest data, a graphical inference may be obtained. A structured representation for the graphical inference may be populated based on objects and/or stylistic elements displayed by the graphical inference, and may indicate (e.g., when compared to structured representations for the reference works) whether the graphical inference exceeds a predetermined level of similarity with respect to the reference works. If the inference exceeds the predetermined level of similarity, performance of an action set may be initiated to manage an impact of similarities between the graphical inference and the reference works.

### FIELD

Embodiments disclosed herein relate generally to inference models (e.g., artificial intelligence models). More particularly, embodiments disclosed herein relate to systems and methods to manage generative inference models.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components, and hosted entities such applications, may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show data flow diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing inference models. The inference models may be used to provide computer-implemented services (e.g., inference generation) for downstream consumers and/or may facilitate computer-implemented services provided by the downstream consumers. For example, the inference models may include generative inference models, which may be used to infer new instances of graphical data (e.g., data relating to the visual arts or computer graphics) when provided with ingest data (e.g., a prompt).

To provide the computer-implemented services, the inference models may be trained using training data. For example, to train a generative inference model to produce unstructured data such as images or a video in response to a prompt, the training data may include reference works of various creators (e.g., existing images and/or video of various artists).

However, depending on a variety of factors (e.g., constraints of the prompt, training data variety, inference model capabilities, etc.), an inference (e.g., a graphical inference) generated using the generative inference model may be substantially similar to (or same as) portions of reference works (e.g., the training data, the ingest data, and/or other data). In such cases, downstream use of the inference may lead to issues such as copyright infringement, plagiarism, and/or other types of noncompliant use of the inference model with respect to laws, regulations, or policies. To identify such inferences, comparisons between the inference and the reference works may be made to determine whether similarities between the inference and portions of the reference works constitute plagiarism and/or copyright infringement. However, any similarities between the inference and the reference works may be difficult to measure by virtue of the inference and the reference works including (potentially large volumes of) unstructured data.

Therefore, to improve the likelihood of compliant use of generative inference models, structured representations for inferences obtained using the generative inference models may be analyzed to identify likely instances of noncompliance (e.g., plagiarism, copyright infringement) of the inferences with respect to the reference works. To do so, the structured representations for the inferences may be obtained based on concepts displayed by the inferences (e.g., information presented by the inferences).

For example, an inference may depict a scene in which information regarding human interpretable objects and/or information regarding stylistic elements may be present. The information may be identified from the inference using a schema, and may be used to populate a structured representation for the inference. Structured representations for the reference works may be obtained in a similar manner (e.g., based on similar concepts displayed by the reference works) for comparison with the structured representation for the inference.

The structured representations may provide for a means of measuring (e.g., qualitatively and/or quantitatively) similarity between the inference and the reference works. For example, a level of similarity between the inference and the reference works may indicate a likelihood that the inference plagiarizes the reference works or that the inference infringes copyrighted materials of the reference works. Thus, when compared to a threshold, the level of similarity may indicate whether the inference is acceptable for downstream use (e.g., compliant with laws, regulations, and/or policies).

By doing so, inferences that are unacceptable for downstream use (e.g., in view of plagiarism, copyright infringement) may be identified, and actions may be initiated in order to manage associated potential impacts.

Thus, embodiments disclosed herein may address, among others, the technical problem of managing copyright infringement and/or plagiarism facilitated by generative inference models with respect to reference works. By managing impacts of similarities between the inferences and the reference works, the generative inference models may be more likely to provide the desired (e.g., legally compliant) computer-implemented services.

In an embodiment, a method for managing a generative inference model is provided. The method may include: obtaining a graphical inference generated using the generative inference model and ingest data; populating a structured representation for the graphical inference using a schema; and, making a determination regarding whether the structured representation for the graphical inference indicates that the graphical inference exceeds a predetermined level of similarity with respect to reference works.

In a first instance of the determination where the structured representation for the graphical inference indicates that the graphical inference does not exceed the predetermined level of similarity, the method may include providing the graphical inference to a downstream consumer as a computer-implemented service.

In a second instance of the determination where the structured representation for the graphical inference indicates that the graphical inference exceeds the predetermined level of similarity, the method may include initiating performance of an action set to manage an impact of similarities between the graphical inference and the reference works.

The schema may be usable to identify information regarding human interpretable objects present in a depiction of a scene defined by the graphical inference. The information may include: objects present in the depiction of the scene; positions of the objects within the scene; and, directions of facing of the objects within the scene.

Making the determination may include obtaining levels of similarity between the structured representation for the graphical inference and structured representations for the reference works, and comparing the levels of similarity to a similarity threshold. The similarity threshold may be based on levels of similarity between the reference works.

Obtaining the levels of similarity may include performing a sub-graph analysis of the structured representation for the graphical inference with respect to portions of the structured representations for the reference works to identify whether a portion of the structured representation for the graphical inference substantially matches any of the portions of the structured representations for the reference works. The levels of similarity may indicate likelihoods that the graphical inference plagiarizes the reference works.

The schema may be usable to identify information regarding stylistic elements present in a depiction of a scene defined by the graphical inference. The information may include: a pattern present in the scene; a color scheme present in the scene; and, a perspective of the scene.

The pattern may be one pattern selected from a list patterns consisting of: a number of brushstrokes used to depict elements of the scene; a relative orientation of the number of brushstrokes; and, a size of the number of brushstrokes.

Making the determination may include transforming a stylistic element of the stylistic elements present in the depiction of the scene to identify whether the stylistic element matches any of the stylistic elements present in depictions of scenes defined by the reference works. The stylistic element may include a first brushstroke pattern in a first orientation and a first position relative to the scene.

The action set may include obtaining a description of the similarities between the graphical inference and the reference works. The action set may include preventing provision of the graphical inference to the downstream consumer. The action set may include at least one action that, when performed, modifies operation and/or use of the generative inference model to reduce a likelihood that a future graphical inference generated using the generative inference model and the ingest data plagiarizes the reference works.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the method when the computer instructions are executed by the processor.

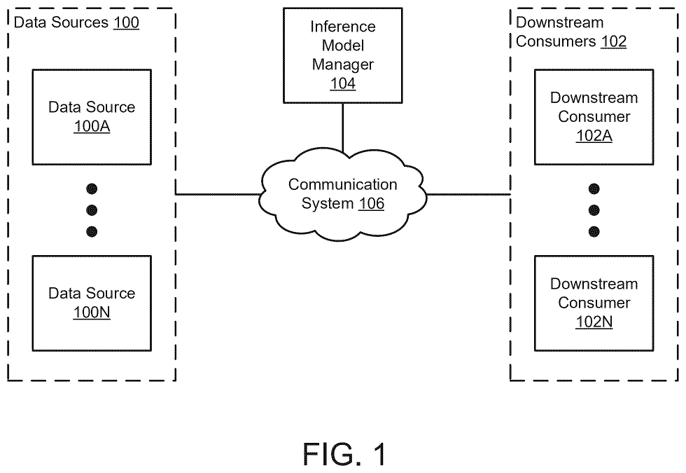

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided, at least in part, using inference models and/or inferences obtained using the inference models.

To provide the computer-implemented services, the inference models may be trained, using training data, to generate inferences when provided with a prompt (e.g., ingest data). The inference models may include generative inference models; therefore, the inferences may include new instances of data created by the generative inference models based on learned associations from and/or an understanding of the training data. For example, the inference models may be trained using unstructured data, such as human interpretable text, images, video, and/or other types of graphical data, to generate graphical inferences. The graphical inferences may include new instances of graphical data such images and/or video of any dimension. The graphical inferences may be provided to downstream consumers as a computer-implemented service and/or in order to facilitate computer-implemented services provided by the downstream consumers.

However, inferences obtained using the generative inference models may be (intentionally or unintentionally) similar to reference works (e.g., the training data, the ingest data, and/or other data, such as derived data). For example, an inference generated by the generative inference model may be similar to a portion of the reference works to an extent that constitutes plagiarism, copyright infringement, and/or other types of prohibited use of the inference with respect to the reference works.

Downstream use of the (prohibited) inference may lead to legal and/or regulatory issues that may negatively impact an operator of the generative inference model, users of the generative inference model (e.g., downstream consumers of the inference), and/or the computer-implemented services provided using the generative inference model. In other words, distribution and/or use of the inference may be out of compliance with laws, regulations, policies, and/or guidelines, which may prevent the provision of desired (e.g., legally compliant) computer-implemented services.

In general, embodiments disclosed herein may provide methods, systems, and/or devices for managing generative inference models in a manner that increases a likelihood of providing the desired computer-implemented services. To do so, graphical inferences obtained using the generative inference models may be analyzed in order to obtain a set of concepts (e.g., information regarding human interpretable objects and/or stylistic elements) associated with the graphical inferences. The information may include characteristics of the (human interpretable) objects and the stylistic elements that are identifiable by a person but that are not explicitly described as such in the graphical inference.

For example, the graphical inference may define a scene. Information regarding (human interpretable) objects present in the scene may include a description of the objects, positions of the objects, directions of facing of the objects, etc. Human interpretable objects may include, for example, people, characters, animals, mythical creatures, plants, and/or inanimate things (e.g., a pencil, a book). Information regarding stylistic elements present in the scene may include a pattern present in the scene, a color scheme present in the scene, a perspective of the scene, etc. For example, the pattern present in the scene may include a relative number of brushstrokes used to depict elements (e.g., objects, other elements) of the scene, a relative orientation of the number of brushstrokes, a size of the number of brushstrokes, etc. The information may be identified (e.g., using schemas) and may be used to populate a structured representation for the graphical inference, such as a graph-structured data model.

Structured representations for the reference works for the generative inference model may be obtained in a similar fashion for comparison with the structured representation for the graphical inference. As the graphical inference and the reference works may include unstructured data, by obtaining their structured representations, a means for quantitative evaluation of similarities between the inference and the reference works may be provided. The quantitative evaluation may be used to predict a likelihood of use of the inference being prohibited with respect to the reference works.

By doing so, embodiments disclosed herein may improve identification of similarities between the inferences and the reference works so that potential noncompliance of computer-implemented services may be identified and mitigated timely. The system may do so by initiating performance of actions in order to manage impacts of the similarities.

To provide the above noted functionality, the system of FIG. 1 may include data sources 100, downstream consumers 102, inference model manager 104, and communication system 106. Each of these components is discussed below.

Data sources 100 may include any type and/or number of data sources (e.g., 100A, 100N). Each data source of data sources 100 may include hardware and/or software components configured to obtain data, store data, provide data to other entities, and/or to perform any other task to facilitate performance of the computer-implemented services. All, or a portion, of data sources 100 may provide (and/or participate in and/or support the) computer-implemented services to various devices operably connected to data sources 100. Different data sources may provide similar and/or different computer-implemented services.

For example, data sources 100 may be used to obtain (i) training data usable to train inference models (e.g., generative inference models), (ii) ingest data usable to prompt inference models to generate an inference, and/or (iii) other data (e.g., reference works). Data sources 100 may include data repositories (e.g., training data repositories, reference works repositories), and may provide data to (e.g., allow access to data by) inference model manager 104.

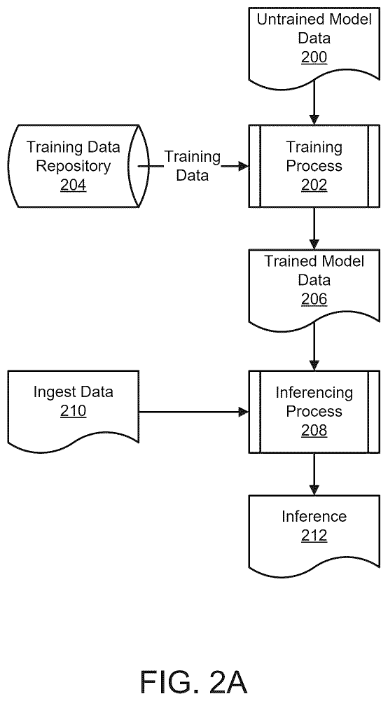

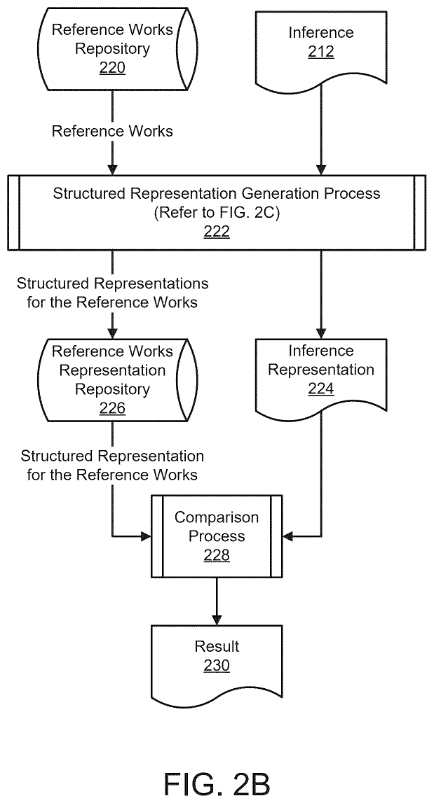

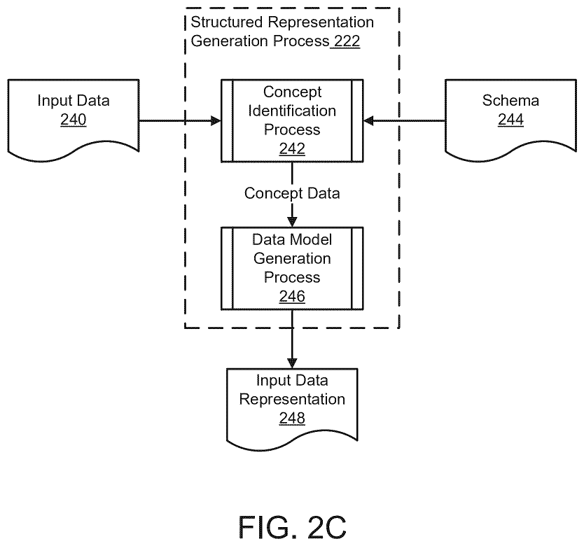

Inference model manager 104 may perform tasks relating to management of and/or facilitation of use of inference models. For example, inference model manager 104 may manage (e.g., facilitate) training processes for the inference models, inferencing processes using the inference models, and/or distribution of inferences obtained using the inference models to downstream consumers 102. Refer to the discussion of FIG. 2A for more information regarding training and/or inferencing processes.

Downstream consumers 102 may provide and/or consume all, or a portion of, the computer-implemented services. Downstream consumers 102 may include any number of downstream consumers (e.g., 102A, 102N) and may include, for example, businesses, individuals, and/or computers that may use inference data to improve decision-making and/or automate tasks. Downstream consumers 102 may subscribe to services using, in part, inference models managed by inference model manager 104.

For example, downstream consumers 102 may provide prompts (e.g., ingest data) to generative inference models, and consume graphical inferences generated in response to the prompts. The graphical inferences may include (new instances of) any type of graphical data that may depict photographs, drawings, line art, mathematical graphs, line graphs, charts, diagrams, typography, numbers, symbols, geometric designs, maps, engineering drawings, etc., as well as any sequence of graphical data (e.g., multi-dimensional images, video).

To manage potential similarities between inferences (e.g., obtained using generative inference models) and reference works, inference model manager 104 may (i) identify (e.g., using a schema) information regarding concepts displayed by the inferences (and the reference works), (ii) obtain (e.g., populate) structured representations for the inferences (and for the reference works) using the identified concepts, (iii) perform comparison processes between the structured representations for the inferences and structured representations for the reference works to determine acceptability of the inferences (e.g., the acceptability being based on a predetermined level of similarity of the inferences with respect to the reference works), and/or (iv) initiate performance of actions relating to inference management, inference model management, and/or detection of noncompliance (e.g., plagiarism, copyright infringement). Refer to the discussion of FIGS. 2B-2C for more information regarding generation and comparison of structured representations.

When providing their functionality, any of (and/or components thereof) data sources 100, downstream consumers 102, and/or inference model manager 104 may perform all, or a portion, of the actions and methods illustrated in FIGS. 2A-4.

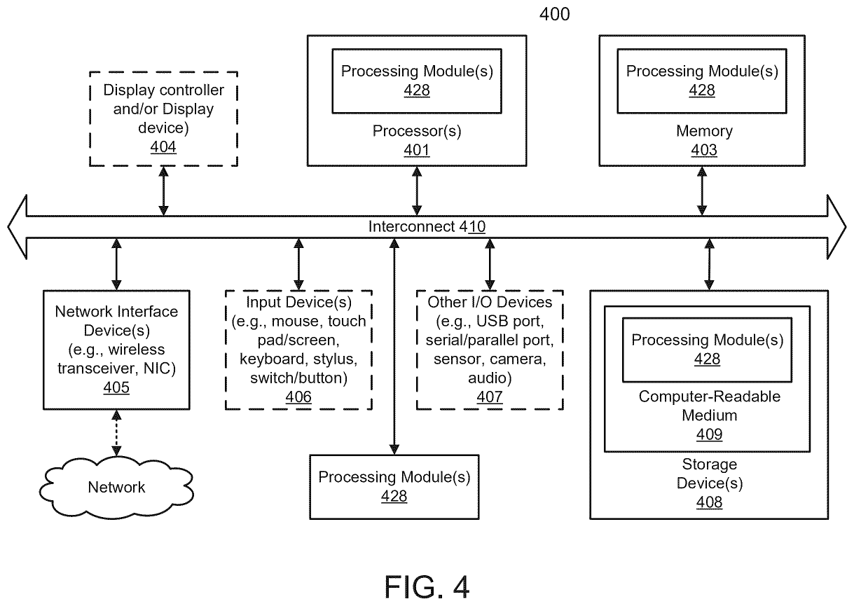

Any of (and/or components thereof) data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In these diagrams, flows of data and processing of data are illustrated using different sets of shapes. A first set of shapes (e.g., 200, 206, etc.) is used to represent data structures, a second set of shapes (e.g., 202, 208, etc.) is used to represent processes performed using and/or that generate data, and a third set of shapes (e.g., 204, 220, etc.) is used to represent large scale data structures such as databases.

Turning to FIG. 2A, a first data flow diagram in accordance with an embodiment is shown. The first data flow diagram may illustrate data used in and data processing performed when facilitating operation of an inference model. In the example shown in FIG. 2A, operation of the inference model may include a training process and an inferencing process. The training process may include, for example, initial training of an (untrained) inference model, retraining of an inference model, and/or fine-tuning of an inference model. The inferencing process may include, for example, obtaining inferences using an inference model.

To obtain a trained inference model, a management entity (e.g., inference model manager 104) may facilitate performance of training process 202. Training process 202 may include training an untrained inference model defined by untrained model data 200.

Untrained model data 200 may include information relating to model architecture, hyperparameters, and/or other information regarding an untrained inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. For example, the inference model may include a generative inference model that utilizes a transformer architecture.

During training process 202, untrained model data 200 may be updated using training data from training data repository 204. The training data stored in training data repository 204 may be obtained from any number of data sources (e.g., 100). For example, if the inference model is being trained for image generation, the training data may include a corpus of labeled image samples (e.g., labeled using human interpretable text). As the inference model is exposed to large numbers of relationships and/or patterns in the training data, attention mechanisms, weights and/or other parameters of untrained model data 200 may be modified to obtain trained model data 206. Trained model data 206 may be used during inferencing processes to generate inferences in response to ingest data.

To manage trained inference models, trained model data 206 may be stored in a trained model repository (not shown). For example, trained model data 206 may include inference model data (e.g., information regarding the architecture and/or hyperparameters of the inference model) and/or model parameter values of the inference model (e.g., weights). The trained model repository may store and/or provide access to any number of inference models (e.g., trained model data). For example, access to trained model data 206 may be provided to facilitate performance of inferencing process 208.

During inferencing process 208, a trained inference model may be obtained based on information (e.g., node information, weight information, connection information, activation functions, attention mechanisms, etc.) included in trained model data 206. Inferencing process 208 may include generating inferences based on ingest data 210.

Ingest data 210 may include a portion of data for which an inference is desired to be obtained. For example, ingest data 210 may include a prompt (e.g., a request) obtained from a downstream consumer (e.g., of downstream consumers 102) and/or another data source (e.g., of data sources 100). Ingest data 210 may not include labeled data and, thus, an association for ingest data 210 may not be known. During inferencing process 208, the trained inference model may read ingest data 210 and predict an output likely to be associated with the input (e.g., generate an inference).

For example, ingest data 210 may include a prompt. The prompt may include graphical data (e.g., or video) and/or textual data (e.g., human interpretable text), and inference 212 may include a graphical inference that is likely to be associated with ingest data 210 according to relationships and/or patterns learned by the trained inference model during training process 202. During inferencing process 208, inference 212 may be obtained. Inference 212 may be provided to downstream consumers (e.g., 104) as a computer-implemented service and/or to facilitate further computer-implemented services.

Thus, using the data flows shown in FIG. 2A, computer-implemented services may be facilitated using trained inference models via inference generation. However, the inferences generated by trained inference models may be subject to compliance with laws, regulations, etc., and therefore may be screened for such compliance prior to being made available for downstream use. By doing so, negative impacts associated with noncompliance may be prevented and/or mitigated. Methods for screening inferences obtained using (generative) inference models may be discussed with respect to FIGS. 2B-2C.

Turning to FIG. 2B, a second data flow diagram in accordance with an embodiment is shown. The second data flow diagram may illustrate data used in and data processing performed during screening of graphical inferences for similarities to reference works. The graphical inferences may be screened for similarities to the reference works using structured representations for data.

To obtain the structured representations, structured representation generation process 222 may be performed. During structured representation generation process 222, structured representations for the reference works from reference works repository 220 and a structured representation for inference 212 (e.g., a graphical inference) may be obtained. As discussed with respect to FIG. 2A, inference 212 may be obtained during an inferencing process using a generative inference model in response to ingest data.

During structured representation generation process 222, reference works from reference works repository 220 may be identified and/or selected. For example, all or a subset of reference works from reference works repository 220 may be selected. Reference works repository 220 may include training data used to train the generative inference model, data derived from the training data, and/or other data (e.g., ingest data). For example, if the generative inference model is trained to generate graphical inferences, then the reference works selected from reference works repository 220 may include training samples of images, video, and/or other graphical data (e.g., samples used to train the generative inference model), samples of graphical data derived from the training samples, and/or other relevant samples of graphical data (e.g., of the same and/or similar topic, by the same and/or similar artist).

Structured representation generation process 222 may include any types of processes for interpreting graphical data and/or textual data such that a structured data model may be populated from the interpretation. For example, during structured representation generation process 222, concepts displayed by input data (e.g., inference 212, portions of reference works) may be identified, and structured data models may be generated for the input data based on the identified concepts. For example, the structured data models may include graph-structured data models. Refer to the discussion of FIG. 2C for an example of a structured representation generation process.

During structured representation generation process 222, structured representations for the reference works may be obtained based on concepts of (portions of) reference works, and/or inference representation 224 may be obtained based on concepts of inference 212. Inference representation 224 may include a structured representation for inference 212.

Any of the structured representations for the reference works obtained during structured representation generation process 222 or from other similar processes may be stored in reference works representation repository 226. For example, portions of the structured representations for the reference works stored in reference works representation repository 226 may have been obtained prior to obtaining inference 212 and/or prior to obtaining the structured representation for inference 212.

Reference works representation repository 226 may store any number and/or type of structured representations for the reference works. The structured representations for the reference works may be stored with identifiers and/or other information usable to identify and/or select structured representations for use by other processes, such as screening inference 212 for similarities to the reference works.

To screen the inferences for similarities to the reference works, comparison process 228 may be performed. During comparison process 228, inference representation 224 and at least one structured representation for the reference works may be compared using any type of data structure comparison algorithm. For example, inference representation 224 may include a graph-structured data model that specifies relationships between concepts of inference 212, and the structured representation for the reference works may include a graph-structured data model that specifies relationships between concepts of the reference works.

The graph-structured data models may include any number of nodes (e.g., that represent concepts displayed by inference 212 or the reference works) and edges connecting the nodes (e.g., that represent relationships between the concepts). In this example, the data structure comparison algorithm may include any type of graph comparison algorithm usable to analyze similarities between the graph-structured data model of inference representation 224 and at least the graph structured data model of the structured representation for the reference works.

During comparison process 228, inference representation 224 and the structured representation for the reference works may be compared at various levels of granularity. For example, structural similarities between two graph-structured data models may be analyzed using methods of alignment to identify portions of the graph-structured data models that may correspond to one another. In other words, a sub-graph analysis of inference representation 224 with respect to the structured representation for the reference works may be performed. For example, matches (or substantial matches, based on a threshold) of sub-structures of the structured data models, semantic relationships, common attributes, and/or combinations thereof may be identified.

Based on the comparisons made during comparison process 228, similarities between inference representation 224 and the structured representation for the reference works may be identified and/or measured. For example, the measurements of similarities may be based on likelihoods of correspondence between identified portions of the graph-structured data models and/or other types of measurements of similarity between two structured data models.

Comparison process 228 may be performed using any number of structured representations for the reference works. Based on the comparisons of portions of structured representations for the reference works and inference representation 224, levels of similarity between inference 212 and the reference works may be obtained. The levels of similarity may be based on any number of comparisons performed during comparison process 228. For example, the levels of similarity may be described using functions of measured similarities between portions of structured representations, and may include numerical values or multi-dimensional values (e.g., vectors). The levels of similarity may indicate, for example, likelihoods that inference 212 plagiarizes the reference works and/or likelihoods of compliance of inference 212 with facilitating desired computer-implemented services.

During comparison process 228, to determine whether the structured representation for the inference indicates that the inference exceeds a predetermined level of similarity with respect to the reference works, the levels of similarity may be compared to any number of similarity thresholds. For example, any number of levels of similarity (e.g., representing any number of portions of the structured representation for the inference) may be required to exceed their corresponding similarity thresholds in order for inference 212 to exceed the predetermined level of similarity with respect to the reference works).

The similarity thresholds may be based on laws, regulations, policies, historical experience, levels of similarity between the reference works, etc., and may include a value or a multi-dimensional value (e.g., a vector). For example, a first reference work may not be considered as plagiarizing a second reference work (e.g., the first reference work and the second reference work may depict known paintings by artists and may include some similarities based on stylistic elements). A level of similarity between the first reference work and the second reference work may be obtained, and a similarity threshold may be established based on the existing level of similarity between the reference works. For example, the similarity threshold may exceed (e.g., to some degree) the level of similarity between the reference works, so that the similarity threshold may be used to identify plagiarism of inferences (e.g., new instances of paintings with similar stylistic elements) with respect to reference works. For example, the inferences may plagiarize the reference works when levels of similarity between the inferences and the reference works exceed the similarity threshold.

To determine whether the structured representation for the inference exceeds the predetermined level of similarity with respect to the reference works based on stylistic elements exhibited by the inference, a stylistic element (of the stylistic elements present in the depiction of the scene defined by the inference) may be transformed to identify whether the stylistic element matches any of the stylistic elements present in depictions of scenes defined by the reference works.

For example, a first stylistic element displayed by the inference may include a first brushstroke pattern in a first orientation and a first position relative to a scene defined by the inference. The first stylistic element may be represented using a first structured representation populated with a first series of values (e.g., of variables of one or more functions). The first stylistic element may be transformed (e.g., rotated, dilated, translated, reflected) in an attempt to match the (values of the) first stylistic element to (values of) a second stylistic element of the reference works represented using a second structured representation for a portion of the reference works (e.g., a second series of values representing a second brushstroke pattern in a second orientation and a second position relative to a scene defined by the reference works). A level of similarity may be obtained to describe an extent of the manipulation (e.g., transformation) of the first stylistic element that is required to match the second stylistic element (e.g., within a threshold). Any number of levels of similarity may be obtained to measure stylistic elements displayed by the inference.

The levels of similarity and the similarity threshold(s) may be compared with one another in order to obtain result 230. Result 230 may indicate whether inference 212 is acceptable (e.g., does not exceed the predetermined level of similarity with respect to the reference works, and is likely to facilitate desired computer-implemented services), or unacceptable (e.g., exceeds the predetermined level of similarity with respect to the reference works, and is not likely to facilitate the desired computer-implemented services).

For example, if the level of similarity does not exceed the similarity threshold, then inference 212 may be likely to be compliant with facilitating the desired computer-implemented services. However, if the level of similarity exceeds the similarity threshold, then inference 212 may be likely to be noncompliant with facilitating the desired computer-implemented services (e.g., inference 212 may be likely to plagiarize the reference works).

Result 230 may be a data structure that includes information regarding screening of inference 212 with respect to the reference works. For example, result 230 may include information that indicates a Boolean (e.g., pass or fail) result of comparison process 228, and/or any information usable for obtaining an action set for managing the level of similarity between inference 212 and the reference works.

For example, if inference 212 is considered acceptable, an action of the action set may include providing the inference to a downstream consumer (as part of a computer-implemented service). Or, for example, if inference 212 is considered unacceptable, then the action set may include (i) obtaining a description of the similarities between the inference and the reference works (e.g., using a knowledge graph to text method, based on similarities identified between structured representations for the inference and the reference works), (ii) flagging the inference as unacceptable in order to prevent provision of the inference to a downstream consumer, and/or (iii) an action that, when performed, modifies operation and/or use of the generative inference model. For example, the generative inference model may be retrained, taken offline, replaced with a different generative inference model, etc., to reduce a likelihood of obtaining or providing future inferences that may be considered unacceptable.

As discussed, to obtain structured representations for inferences and/or reference works for use in screening the inferences for similarities to the reference works, a structured representation generation process may be performed. An example of a structured representation generation process is described with respect to FIG. 2C.

Turning to FIG. 2C, a third data flow diagram in accordance with an embodiment is shown. The third data flow diagram may illustrate data used in and data processing performed to obtain structured representations for graphical data during a structured representation generation process. The structured representations may be concept-based. For example, the structured representations may be generated using a set of concepts exhibited by the graphical data. The set of concepts may include information regarding human interpretable objects, stylistic elements, and/or other information. The data flow shown in FIG. 2C may be an example expansion of structured representation generation process 222 shown in FIG. 2B.

To obtain the set of concepts, concept identification process 242 may be performed. During concept identification process 242, concepts (and their relationships) displayed by input data 240 may be extracted and/or inferred from input data 240. Input data 240 may include unstructured graphical data. For example, input data 240 may include an inference (e.g., inference 212), or a portion of reference works (e.g., from reference works repository 220).

During concept identification process 242, various analysis algorithms may be used to analyze input data 240. The analysis algorithms may use machine-learning techniques, rule-based systems, and/or other tools to classify, extract, and/or interpret graphical data of input data 240. For example, an object recognition algorithm may be used to identify objects (e.g., human interpretable objects) displayed by input data 240. Or, for example, information depicted in input data 240 may be converted to text (e.g., human interpretable text) using image or video description tools, audio transcription tools, etc. The text may describe concepts (e.g., objects and/or stylistic elements) associated with input data 240.

During concept identification process 242, a schema (e.g., schema 244) may be selected to analyze input data 240. Concept identification process 242 may use schema 244 to identify information regarding concepts and/or relationships between concepts indicated by input data 240.

Schema 244 may include keywords, predefined tags or categories, and/or other means for rule-based interpretation of unstructured data. For example, schema 244 may be adapted to facilitate identification of information regarding objects present in a depiction of a scene defined by input data 240 such as: objects present in the depiction of the scene, positions of the objects within the scene (e.g., relative to other objects, relative to an arbitrary position in the scene), directions of facing of the objects within the scene (e.g., relative to other objects, relative to an arbitrary position in the scene), and/or other object information of a scene defined by input data 240 (e.g., metadata inferred from information regarding the objects).

For example, schema 244 may be used to identify information regarding human interpretable objects in a depiction of a bowl of fruit. Objects present in the scene may include various pieces of fruit (e.g., an apple, an orange), a bowl, and a surface. In the depiction, the apple may be positioned inside the bowl, facing upwards with respect to the position of the surface (and/or a bottom row of pixels of the depiction), and to the left of the orange (and/or an arbitrary center pixel of the image). It may be inferred from the identified objects that the depiction is of food.

Schema 244 may be selected based on initial analysis of input data 240 (e.g., a classification of input data 240 by topic based on identified objects) and/or based on other information. Different types of schemas may be used to analyze different types of graphical data, and therefore any number of schemas may be used during concept identification process 242. For example, a first schema may be used to identify objects present in the scene defined by input data 240, and a second schema may be used to identify other concepts (e.g., stylistic elements) in the scene.

For example, schema 244 may be adapted to facilitate identification of information regarding stylist elements present in the scene, such as: a pattern present in the scene, a color scheme present in the scene, a perspective of the scene, and/or other information regarding stylistic elements of the scene defined by input data 240. The information regarding stylistic elements present in the scene may be obtained for portions of input data 240. For example, a pattern present in the scene may be identified in the background of the scene (e.g., ignoring portions of the scene where objects are identified), and color schemes maybe identified for the background, each identified object in the scene, etc.

Patterns present in the scene may include a number of brushstrokes used to depict elements of the scene (e.g., portions of the background of, objects identified therein), a relative orientation of the number of brushstrokes (e.g., with respect to other brushstrokes or an arbitrarily chosen orientation), a size of the number of brushstrokes, etc. For example, a brushstroke may include marks that appear to be made using a paintbrush, a palette knife, a pointed object (e.g., pointillism), and/or other tools. The size of the brushstroke may be absolute. For example, the length of the brushstroke may be based on a number of pixels along a medial axis of the brushstroke and the width of the brushstroke may be based on a number of pixels along an axis perpendicular to the medial axis, and/or relative to other types of identified brushstrokes.

Concepts displayed by input data 240 obtained using schema 244 may include statistical characterizations of the information regarding the objects and/or the stylistic elements. For example, the color scheme present in the scene may include identified colors, a number of identified colors, a distribution of the colors, levels of color contrast (e.g., light colors, dark colors), and/or classifications of colors (e.g., pastels, grayscale, shades of a similar color).

The perspective of the scene may include an impression of relative measurements (e.g., height, width, depth, position) of objects depicted in the scene and/or of portions of the scene when viewed from a particular point. For example, information regarding the perspective of portions of input data 240 may be used to classify input data 240 by an artistic movement, such as cubism. In other words, schema 244 may be usable to identify and/or measure concepts (e.g., objects, stylistic elements) and/or relationships between concepts associated with input data 240 that may be useful in determining whether input data 240 is likely to exhibit a style associated with a particular artist.

Input data 240 may be analyzed at various levels of granularity (e.g., in full, or in portions defined by numbers of pixels or by object) using schema 244 to obtain concept data for input data 240. The concept data may include the set of concepts and corresponding relationships identified during concept identification process 242. Concept data may be provided to data model generation process 246 in order to obtain a concept-based structured representation for input data 240.

To obtain the concept-based structured representation, data model generation process 246 may be performed. During data model generation process 246, the concept data may be used to populate (e.g., create) a structured data model of input data 240 (e.g., input data representation 248). For example, input data representation 248 may include a graph-structured data model that specifies relationships between concepts of the concept data using a number of nodes interlinked by edges. For example, the nodes may represent concepts of the concept data, and the edges represent relationships of the concept data. The edges may be based on the relationships between the concepts that are associated by the edges. The nodes and/or edges of the graph-structured data model may include complex representations, such as multi-dimensional vectors.

Input data representation 248 may be similar to inference representation 224 and/or any structured representation for the reference works described in FIG. 2B.

Input data representation 248 may include a structured representation for graphical data, such as an inference (e.g., inference 212) and/or a structured representation for other graphical data, such as the reference works for the inference. The structured representations may be compared during a comparison process to identify inferences that are likely to be noncompliant with providing desired computer-implemented services, and action items for managing the likely noncompliance. Refer to the discussion of FIG. 2B for more information regarding use of the structured representations.

Thus, using the data flows shown in FIGS. 2A-2C, generative inference models may be managed using concept-based structured representations for graphical inferences obtained using the generative inferences models. The concept-based structured representations may provide for classification of the inferences as acceptable or unacceptable. Based on the acceptability of the inferences, the generative inference models may be managed to increase the likelihood of providing desired (e.g., compliant) computer-implemented services.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

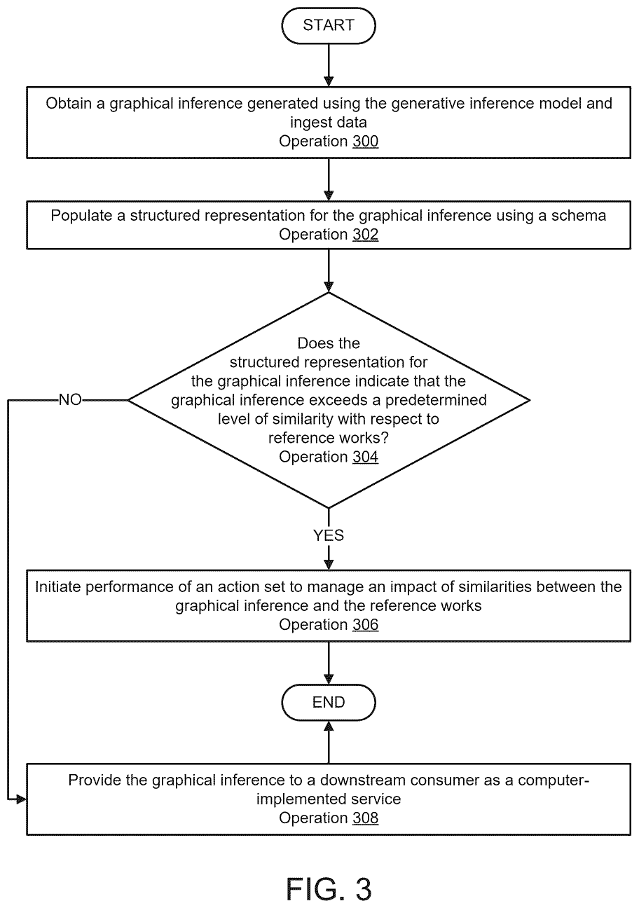

As discussed above, the components of FIG. 1 may perform various methods to manage generative inference models in view of plagiarism and/or copyright infringement. FIG. 3 illustrates a method that may be performed by the components of the system of FIG. 1 and/or by other components. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing a generative inference model in accordance with an embodiment is shown. The method may be performed by any of the components of the system shown in FIG. 1.

At operation 300, a graphical inference generated using the generative inference model and ingest data may be obtained. The graphical inference may be obtained by (i) reading the graphical inference from storage, (ii) receiving the graphical inference (e.g., from another device), (iii) generating the graphical inference, and/or (iv) via other methods. For example, the graphical inference may be generated by prompting the generative inference model to respond to a request using the ingest data (e.g., as discussed with respect to inferencing process 208 of FIG. 2A). The generative inference model may be trained to generate graphical data in response to (graphical and/or textual) ingest data.

At operation 302, a structured representation for the graphical inference may be populated using a schema. The structured representation may be populated by (i) analyzing the graphical inference using the schema to obtain a set of concepts displayed by the graphical inference, and (ii) using the set of concepts to perform a data model generation process (e.g., similar to data model generation process 246 of FIG. 2C). The set of concepts may include human interpretable objects and/or stylist elements displayed by the graphical inference.

The graphical inference may be analyzed by performing a concept identification process similar to concept identification process 242 of FIG. 2C and/or by other methods. For example, the graphical inference may be analyzed using various types of machine-learning techniques and/or using rule-based systems that may be based on the schema.

The schema may be adapted to facilitate identification of at least one concept of the set of concepts. For example, the schema may be usable to identify information regarding human interpretable objects and/or stylistic elements (and their relationships with one another) present in a depiction of a scene defined by the graphical inference. For more information regarding concepts displayed by graphical inferences, refer to the discussion of FIG. 2C.

The structural representation for the graphical representation may be populated based on at least one concept of the set of concepts. The (populated) structured representation for the graphical inference may include a graph-structured data model that specifies relationships between concepts of the set of concepts. Structural representations for reference works for the graphical inference may be obtained (e.g., prior to operation 304) using methods similar to those used to obtain the structural representation for the graphical inference. Refer to the discussion of FIG. 2B for more information regarding reference works.

At operation 304, a determination regarding whether the structured representation for the graphical inference indicates that the graphical inference exceeds a predetermined level of similarity with respect to the reference works may be made. The determination may be made by (i) obtaining levels of similarity between the structured representation for the graphical inference and structured representations for the reference works, (ii) comparing the levels of similarity to a similarity threshold (e.g., during a comparison process).

The levels of similarity may indicate likelihoods that the graphical inference plagiarizes the reference works. The levels of similarity between the graphical inference and the reference works may be obtained, for example, by (i) overlaying (portions of) the structured representation of the graphical inference onto (portions of) the structured representations of the reference works, (ii) evaluating a function of similarity between the structured representation of the graphical inference and the structured representations of the reference works, (iii) a combination thereof, and/or (iv) by other methods. For example, the function of similarity may include any measures of similarity such as Euclidean distance, Manhattan distance, Hamming distance, and/or cosine similarity.

Overlaying the structured representation of the graphical inference onto the structured representations of the reference works may include aligning sub-graphs of the structured representation of the graphical inference with sub-graphs of the structured representations of the reference works using genetic algorithms and/or other types of search algorithms. Each candidate alignment of sub-graphs may be associated with an alignment score, which may be used to identify substantial matches between the structured representations.

For example, the alignment score may be obtained by evaluating an alignment function based on (i) overlaid node-to-node similarity (e.g., based on a function of similarity), (ii) overlaid edge-to-edge similarity (e.g., based on a function of similarity), (iii) skipped nodes and/or edges of the alignment (e.g., based on a penalty function), and/or (iv) other variables for measuring graph alignment. The alignment score may be used to rank order the candidate alignments according to similarity, and the highest rank ordered sub-graph alignment may be selected as the portion of the structured representation of the inference that substantially matches one of the portions of the structured representations of the reference works.

The structured representations may include, for example, graph-structured data models (e.g., graphs), and the graphs may be analyzed with respect to one another at various levels of granularity using any graph similarity method. Therefore, obtaining the levels of similarity may include performing a sub-graph analysis of the structured representation for the graphical inference with respect to portions of the structured representations for the reference works. The sub-graph analysis may be performed using an algorithm that aligns (two or more) graphs in a manner that optimizes similarity between the graphs. The algorithm may include, for example, a genetic algorithm that may be used to identify similarities between the graphs at a local level (e.g., node-level).

The sub-graph analysis may be performed in order to identify similarities between two or more structured representations that may not be similar at a global level (e.g., when taking into account large numbers of nodes and edges), but that may have high levels of similarity at a local level (e.g., when only taking into account small numbers of nodes and edges). Thus, during the comparison process, a portion of the structured representation for the graphical inference may be identified that substantially matches one of the portions of the structured representations for the reference works.

Making the determination may also include transforming a stylistic element of the stylistic elements (of the set of concepts) present in the depiction of the scene defined by the graphical inference to identify whether the stylistic element matches any of the stylistic elements present in depictions of scenes defined by the reference works.

For example, the stylistic element may be a portion of a structured representation for the graphical inference. Therefore, transforming the stylistic element may include evaluating a transform function (e.g., reflection, rotation) using the portion of the structured representation in order to minimize a difference between the transformed stylistic element and a stylist element of the reference works. The levels of similarity between the structured representation for the graphical inference and structured representations for the reference works may be based on parameters used to optimize the transform function.

Comparing the levels of similarity to the similarity threshold may include comparing the levels of similarity (e.g., or an evaluated function thereof) to any number of predetermined levels of similarity. A result of the comparison may indicate whether the graphical inference is acceptable for downstream use.

For example, if the level(s) of similarity exceed the similarity threshold(s) (e.g., the predetermined level(s) of similarity), then the graphical inference may be considered unacceptable, and the method may proceed to operation 306. Otherwise, the graphical inference may be considered acceptable, and the method may proceed to operation 308.

At operation 308, the (acceptable) graphical inference may be provided to a downstream consumer as a computer-implemented service. The graphical inference may be provided to the downstream consumer via (i) transmission via a message, (ii) storing in a storage with subsequent retrieval by the downstream consumer, (iii) a publish-subscribe system where the downstream consumer subscribes to updates from a management entity of the generative inference model thereby causing a copy of the graphical inference to be propagated to the downstream consumer, and/or (iv) other processes. For example, the graphical inference may be provided to the downstream consumer during an inferencing process initiated by the downstream consumer.

The graphical inference may be used (e.g., by the downstream consumer) to provide and/or facilitate provision of a portion of the desired computer-implemented services. For example, the graphical inference be consumed by a downstream consumer, and/or provided to (e.g., stored at) a data center for future use.

The method may end following operation 308.

Returning to operation 304, the method may proceed to operation 306 following operation 304 when the graphical inference is considered unacceptable.

At operation 306, performance of an action set may be initiated to manage an impact of similarities between the graphical inference and the reference works. Performance of the action set may be initiated by providing instructions for performing an action of the action set to an entity that may execute the instructions. Initiating the action set may also include performing an action of the action set.

Performing the action set may include (i) preventing provision of the graphical inference to the downstream consumer, (ii) obtaining a description of similarities between the graphical inference and the reference works, (iii) performing at least one action that modifies operation and/or use of the generative inference model to reduce a likelihood that a future graphical inference generated using the generative inference model and the ingest data plagiarized the reference works, and/or (iv) performing other actions.

Preventing provision of the graphical inference to the downstream consumer may include (i) flagging the graphical inference as unacceptable, (ii) interrupting transfer of the graphical inference to the downstream consumer, and/or (iii) notifying the downstream consumer that the graphical inference may not be provided.

Obtaining a description of similarities between the graphical inference and the reference works may include (i) reading the description from storage, (ii) receiving the description (e.g., from another device), (iii) generating the description, and/or (iv) via other methods. For example, generating the description may include (i) identifying portions of the structured representation for the graphical inference and the structured representations for the reference works that substantially match, and (ii) providing the portions to a knowledge graph to text generator to obtain a human interpretable description of the identified portions.

Performing the at least one action that modifies operation and/or use of the generative inference model may include (i) retraining and/or fine-tuning the generative inference model and/or (ii) limiting or preventing use of the generative inference model.

The method may end following operation 306.

Thus, using the method shown in FIG. 3, embodiments disclosed herein may manage operation of a generative inference model in accordance with laws, regulations, and/or policies that may regulate levels of similarities between graphical inferences generated using the generative inference model and reference works. The operation of the generative inference models may be managed based on the levels of similarities in a manner that increases the likelihood of providing desired computer-implemented services using the generative inference models.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMAX transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid-state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components, or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing a generative inference model, the method comprising:
obtaining a graphical inference generated using the generative inference model and ingest data;
populating a structured representation for the graphical inference using a schema;
making a determination regarding whether the structured representation for the graphical inference indicates that the graphical inference exceeds a predetermined level of similarity with respect to reference works;
in a first instance of the determination where the structured representation for the graphical inference indicates that the graphical inference does not exceed the predetermined level of similarity:
providing the graphical inference to a downstream consumer as a computer-implemented service; and
in a second instance of the determination where the structured representation for the graphical inference indicates that the graphical inference exceeds the predetermined level of similarity:
initiating performance of an action set to manage an impact of similarities between the graphical inference and the reference works.

2. The method of claim 1, wherein the schema is usable to identify information regarding human interpretable objects present in a depiction of a scene defined by the graphical inference.

3. The method of claim 2, wherein the information comprises:
objects present in the depiction of the scene;
positions of the objects within the scene; and
directions of facing of the objects within the scene.

4. The method of claim 2, wherein making the determination comprises:
obtaining levels of similarity between the structured representation for the graphical inference and structured representations for the reference works; and
comparing the levels of similarity to a similarity threshold.

5. The method of claim 4, wherein the similarity threshold is based on levels of similarity between the reference works.

6. The method of claim 4, wherein obtaining the levels of similarity comprises:
performing a sub-graph analysis of the structured representation for the graphical inference with respect to portions of the structured representations for the reference works to identify whether a portion of the structured representation for the graphical inference substantially matches any of the portions of the structured representations for the reference works.

7. The method of claim 4, wherein the levels of similarity indicate likelihoods that the graphical inference plagiarizes the reference works.

8. The method of claim 1, wherein the schema is usable to identify information regarding stylistic elements present in a depiction of a scene defined by the graphical inference.

9. The method of claim 8, wherein the information comprises:
a pattern present in the scene;
a color scheme present in the scene; and
a perspective of the scene.

10. The method of claim 9, wherein the pattern is one pattern selected from a list patterns consisting of:
a number of brushstrokes used to depict elements of the scene;
a relative orientation of the number of brushstrokes; and
a size of the number of brushstrokes.

11. The method of claim 8, wherein making the determination comprises:
transforming a stylistic element of the stylistic elements present in the depiction of the scene to identify whether the stylistic element matches any of the stylistic elements present in depictions of scenes defined by the reference works.

12. The method of claim 11, wherein the stylistic element comprises a first brushstroke pattern in a first orientation and a first position relative to the scene.

13. The method of claim 1, wherein the action set comprises obtaining a description of the similarities between the graphical inference and the reference works.

14. The method of claim 1, wherein the action set comprises preventing provision of the graphical inference to the downstream consumer.

15. The method of claim 1, wherein the action set comprises at least one action that, when performed, modifies operation and/or use of the generative inference model to reduce a likelihood that a future graphical inference generated using the generative inference model and the ingest data plagiarizes the reference works.

16. A non-transitory machine-readable medium having instructions stored therein, which when executed by a processor, cause the processor to perform operations for managing a generative inference model, the operations comprising:
obtaining a graphical inference generated using the generative inference model and ingest data;
populating a structured representation for the graphical inference using a schema;
making a determination regarding whether the structured representation for the graphical inference indicates that the graphical inference exceeds a predetermined level of similarity with respect to reference works;
in a first instance of the determination where the structured representation for the graphical inference indicates that the graphical inference does not exceed the predetermined level of similarity:
providing the graphical inference to a downstream consumer as a computer-implemented service; and
in a second instance of the determination where the structured representation for the graphical inference indicates that the graphical inference exceeds the predetermined level of similarity:
initiating performance of an action set to manage an impact of similarities between the graphical inference and the reference works.

17. The non-transitory machine-readable medium of claim 16, wherein the schema is usable to identify information regarding human interpretable objects present in a depiction of a scene defined by the graphical inference.

18. The non-transitory machine-readable medium of claim 17, wherein the information comprises:
objects present in the depiction of the scene;
positions of the objects within the scene; and
directions of facing of the objects within the scene.

19. A data processing system, comprising:
a processor; and
a memory coupled to the processor to store instructions, which when executed by the processor, cause the processor to perform operations for managing a generative inference model, the operations comprising:
obtaining a graphical inference generated using the generative inference model and ingest data,
populating a structured representation for the graphical inference using a schema;
making a determination regarding whether the structured representation for the graphical inference indicates that the graphical inference exceeds a predetermined level of similarity with respect to reference works,
in a first instance of the determination where the structured representation for the graphical inference indicates that the graphical inference does not exceed the predetermined level of similarity:
providing the graphical inference to a downstream consumer as a computer-implemented service, and
in a second instance of the determination where the structured representation for the graphical inference indicates that the graphical inference exceeds the predetermined level of similarity:
initiating performance of an action set to manage an impact of similarities between the graphical inference and the reference works.

20. The data processing system of claim 19, wherein the schema is usable to identify information regarding human interpretable objects present in a depiction of a scene defined by the graphical inference.
